(19) United States
(12) Patent Application Publication
(10) Pub. No.: US 2021/0129870 A1
(43) Pub. Date: May 6, 2021

(54) APPARATUS AND METHOD FOR PROVIDING DELIVERY SERVICE USING AUTONOMOUS VEHICLE

(71) Applicant: LG Electronics Inc., Seoul (KR)

(72) Inventor: Jung Kyun JUNG, Seoul (KR)

(21) Appl. No.: 16/782,360

(22) Filed: Feb. 5, 2020

(30) Foreign Application Priority Data
Nov. 6, 2019 (KR) 10-2019-0141133

(51) Int. Cl. B60W 60/00; H04L 9/32; G06Q 10/08; G08G 1/09; G08G 1/00; B60P 3/00; G05D 1/00; G05D 1/02; B60R 25/24

(52) U.S. Cl. CPC B60W 60/00256; H04L 9/3228; G06Q 10/083; G08G 1/091; G08G 1/205; B60P 3/007; B60W 2554/40; G05D 1/0276; B60R 25/24; G05D 2201/0213; B60W 2530/10; B60W 2556/45; G05D 1/0088

(57) ABSTRACT

Disclosed herein is an apparatus for providing delivery service by using an autonomous vehicle according to an embodiment of the present disclosure. The apparatus for providing delivery service may include a receiver configured to receive order information, a controller configured to generate delivery schedule information based on the order information, and a transmitter configured to transmit the delivery schedule information under the control of the controller. The order information may include the weight of a delivery article, a delivery destination, and a security key.

At least one among an autonomous vehicle, a user terminal, or a server, according to an embodiment of the present disclosure, may be associated or integrated with an artificial intelligence (AI) module, a drone (unmanned aerial vehicle (UAV)), a robot, an augmented reality (AR) device, a virtual reality (VR) device, a 5G service related device, and the like.

### CROSS-REFERENCE TO RELATED APPLICATION

This present application claims the benefit of priority to Korean Patent Application No. 10-2019-0141133, entitled “APPARATUS AND METHOD FOR PROVIDING DELIVERY SERVICE USING AUTONOMOUS VEHICLE,” filed on Nov. 6, 2019, in the Korean Intellectual Property Office, the entire disclosure of which is incorporated herein by reference.

### BACKGROUND

### 1. Technical Field

The present disclosure relates to a technology relating to a parcel delivery service. More particularly, the present disclosure relates to an apparatus and method for providing parcel delivery service for receiving a parcel in the absence of a recipient by using an autonomous vehicle.

### 2. Description of Related Art

With the development of smartphone-oriented Internet shopping malls, an innovative delivery service represented by ultra-fast delivery service has been introduced.

In particular, with the recent development of unmanned robots and drones, when a user orders articles on the Internet, a technology for quickly delivering the articles to the user's home is being applied on a trial basis.

Korean Patent Application Publication No. 10-2017-011341 (hereinafter referred to as “Related Art”), which is one of the related arts relating to the above-described delivery service, discloses a method for delivering an article by allowing an unmanned robot, into which delivery information is inputted, to load the article therein, move to a delivery destination corresponding to the delivery information, identify a user who ordered the article when the robot arrives near the delivery destination, and deliver the article to the user when the user is identified.

However, according to the delivery method disclosed in Related Art, the article cannot be delivered when the user who ordered the article is not near the delivery destination.

For this reason, the user who orders the article needs to wait at home or at work to receive the article at a delivery time.

Therefore, there is a need for an apparatus and method capable of accurately delivering the article even when the user who ordered the article is not present at the delivery destination.

### RELATED ART DOCUMENT

Related Art: Korean Patent Application Publication No. 10-2017-0110341 (published Oct. 11, 2017)

### SUMMARY OF THE INVENTION

The present disclosure is directed to providing an apparatus and method for providing parcel delivery service by using an autonomous vehicle in which a delivery article may be delivered by calling the autonomous vehicle owned by a user, instead of performing an operation for directly identifying the user who ordered the article, which is a cause of the issue associated with the related art discussed above.

The present disclosure is further directed to providing an apparatus and method for providing parcel delivery service by using an autonomous vehicle in which a delivery article may be delivered by calling the autonomous vehicle to a stopping location for a delivery vehicle, without a need for a courier to individually move articles to delivery destinations by using the delivery vehicle or to move the articles to the delivery destinations by using expensive equipment such as a drone.

Aspects of the present disclosure are not limited to the above-mentioned aspects, and other technical aspects not mentioned above will be clearly understood by those skilled in the art from the following description.

In order to achieve the above-described objects, an apparatus for providing parcel delivery service by using an autonomous vehicle according to an embodiment of the present disclosure may implement an apparatus for receiving a delivery article in a loading space of the autonomous vehicle by moving the autonomous vehicle to a reception location for the article, when the autonomous vehicle receives a parcel delivery call.

Specifically, the apparatus for providing delivery service by using an autonomous vehicle, according to this embodiment of the present disclosure, may include a receiver configured to receive order information, a controller configured to generate delivery schedule information based on the order information, and a transmitter configured to transmit the delivery schedule information under control of the controller. The order information may include a weight of the delivery article, a delivery destination, and a security key. The delivery schedule information may include a reception location and an estimated reception time for the delivery article. The transmitter may transmit the security key under the control of the controller. The security key may include information for unlocking a loadable space of the autonomous vehicle that receives the delivery article.

According to this embodiment of the present disclosure, the controller may determine the estimated reception time based on the delivery destination, and may determine the reception location for the delivery article based on the delivery destination and the weight of the delivery article.

According to this embodiment of the present disclosure, in determining the reception location for the delivery article, the controller may determine a distance between a parcel delivery vehicle that delivers the delivery article and the autonomous vehicle that receives the delivery article to be inversely proportional to the weight of the delivery article.

According to this embodiment of the present disclosure, the controller may receive traffic information via the receiver, and may update the delivery schedule information based on the traffic information.

According to this embodiment of the present disclosure, the controller may generate an autonomous vehicle call signal based on the delivery schedule information, and may transmit the generated autonomous vehicle call signal via the transmitter.

According to this embodiment of the present disclosure, the security key may be a one-time key that is deactivated in response to confirmation of reception of the delivery article.

According to this embodiment of the present disclosure, the controller may determine the reception location for the delivery article based on a regional characteristic of the delivery destination, and may determine a call range to transmit the autonomous vehicle call signal according to the regional characteristic focusing on the reception location for the delivery article. The regional characteristic may include a characteristic relating to presence or absence of a parking lot and a characteristic relating to whether an external vehicle is accessible.

According to another embodiment of the present disclosure, an apparatus for providing delivery service that is installed in an autonomous vehicle that communicates with a parcel delivery server that generates delivery schedule information based on order information including a security key and generates an autonomous vehicle call signal based on the generated delivery schedule information, may include a vehicle receiver configured to receive the autonomous vehicle call signal and real-time traffic information, and a vehicle controller configured to control an operation to reach a reception location at an estimated reception time designated by the autonomous vehicle call signal based on the real-time traffic information in response to reception of the autonomous vehicle call signal. The vehicle controller may unlock a door of a loadable space of the vehicle in response to reception of the security key via the vehicle receiver.

According to this embodiment of the present disclosure, the vehicle receiver may receive the autonomous vehicle call signal based on a downlink (DL) grant of a 5G network connected to operate in an autonomous driving mode.

A method for providing delivery service by using an autonomous vehicle according to still another embodiment of the present disclosure may include receiving order information, generating delivery schedule information based on the order information, transmitting the delivery schedule information, and transmitting a security key. The order information may include a weight of a delivery article, a delivery destination, and the security key. The delivery schedule information may include a reception location and an estimated reception time for the delivery article. The security key may include information for unlocking a loadable space of the autonomous vehicle that receives the delivery article.

According to this embodiment of the present disclosure, the generating the delivery schedule information may include determining the estimated reception time based on the delivery destination, and determining the reception location for the delivery article based on the delivery destination and the weight of the delivery article.

According to this embodiment of the present disclosure, the determining the reception location for the delivery article may include determining a distance between a parcel delivery vehicle that delivers the delivery article and the autonomous vehicle that receives the delivery article to be inversely proportional to the weight of delivery article.

According to this embodiment of the present disclosure, the delivery service providing method may further include receiving traffic information, and updating the delivery schedule information based on the traffic information.

According to this embodiment of the present disclosure, the delivery service providing method may further include generating an autonomous vehicle call signal based on the delivery schedule information, and transmitting the autonomous vehicle call signal.

According to this embodiment of the present disclosure, the security key may be a one-time key that is deactivated in response to confirmation of reception of the delivery article.

According to this embodiment of the present disclosure, the determining the reception location for the delivery article may include determining the reception location for the delivery article based on a regional characteristic of the delivery destination, and determining a call range to transmit the autonomous vehicle call signal according to the regional characteristic focusing on the reception location for the delivery article. The regional characteristic may include a characteristic relating to presence or absence of a parking lot and a characteristic relating to whether an external vehicle is accessible.

A method for providing delivery service by using an autonomous vehicle, according to still another embodiment of the present disclosure, that communicates with a parcel delivery server that generates delivery schedule information based on order information including a security key and generates an autonomous vehicle call signal based on the generated delivery schedule information, may include receiving the autonomous vehicle call signal, receiving real-time traffic information, controlling an operation to reach a reception location at an estimated reception time based on the real-time traffic information in response to reception of the autonomous vehicle call signal, and unlocking a door of a loadable space of the vehicle in response to reception of the security key.

According to this embodiment of the present disclosure, the receiving the autonomous vehicle call signal may be receiving the autonomous vehicle call signal based on a DL grant of a 5G network connected to operate in an autonomous driving mode.

A computer-readable recording medium recording a program for providing delivery service by using an autonomous vehicle, according to still another embodiment of the present disclosure, the program for providing delivery service by using an autonomous vehicle may cause a computer to perform receiving of order information, generating of delivery schedule information based on the order information, transmitting of the delivery schedule information, and transmitting of a security key. The order information may include a weight of a delivery article, a delivery destination, and the security key. The delivery schedule information may include a reception location and an estimated reception time for the delivery article. The security key may include information for unlocking a door of a loadable space of the autonomous vehicle.

Details of other embodiments are included in the detailed description and drawings.

According to embodiments of the present disclosure, even when a recipient of a delivery article is not present at a delivery destination, the delivery article may be safely received by using the recipient's vehicle.

According to embodiments of the present disclosure, a method for calling an autonomous vehicle to a delivery destination may be used, thereby reducing use of human resources for parcel delivery or costs required to operate an expensive drone in delivering an article from a parcel delivery vehicle to a recipient's address.

Embodiments of the present disclosure are not limited to the embodiments described above, and other embodiments not mentioned above will be clearly understood from the description below.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is a diagram illustrating a system to which an apparatus for providing parcel delivery service by using an autonomous vehicle, according to an embodiment of the present disclosure, is applied.

FIG. 2 is a block diagram illustrating an apparatus for providing parcel delivery service by using an autonomous vehicle installed on a server side according to an embodiment of the present disclosure.

FIG. 3 is a block diagram illustrating an apparatus for providing parcel delivery service by using an autonomous vehicle installed on a vehicle side according to an embodiment of the present disclosure.

FIG. 4 is a diagram illustrating an example of a basic operation of an autonomous vehicle and a 5G network in a 5G communication system.

FIG. 5 is a diagram illustrating an example of an application operation of an autonomous vehicle and a 5G network in a 5G communication system.

FIGS. 6 to 9 are diagrams illustrating examples of operations of an autonomous vehicle using 5G communication.

FIGS. 10 to 12 are operational flow diagrams illustrating a method for providing parcel delivery service by using an autonomous vehicle according to an embodiment of the present disclosure.

FIGS. 13 to 14B are diagrams illustrating an operation of an apparatus for providing parcel delivery service by using an autonomous vehicle installed on a vehicle side according to an embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. Further, in the description of the embodiments of the present disclosure, when it is determined that the detailed description of the related art would obscure the gist of the present disclosure, the description thereof will be omitted. Further, the accompanying drawings are provided for more understanding of the embodiment disclosed in the present specification, but the technical spirit disclosed in the present disclosure is not limited by the accompanying drawings. It should be understood that all changes, equivalents, and alternatives included in the spirit and the technical scope of the present disclosure are included.

Although the terms first, second, third, and the like may be used herein to describe various elements, components, regions, layers, and/or sections, these elements, components, regions, layers, and/or sections should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

As used herein, the singular forms “a,” “an,” and “the” may be intended to include the plural forms as well, unless the context clearly indicates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

A vehicle described in the present specification may refer to a car, an automobile, and a motorcycle. Hereinafter, the vehicle will be exemplified as an automobile.

The vehicle described in the present disclosure may include, but is not limited to, a vehicle having an internal combustion engine as a power source, a hybrid vehicle having an engine and an electric motor as a power source, and an electric vehicle having an electric motor as a power source.

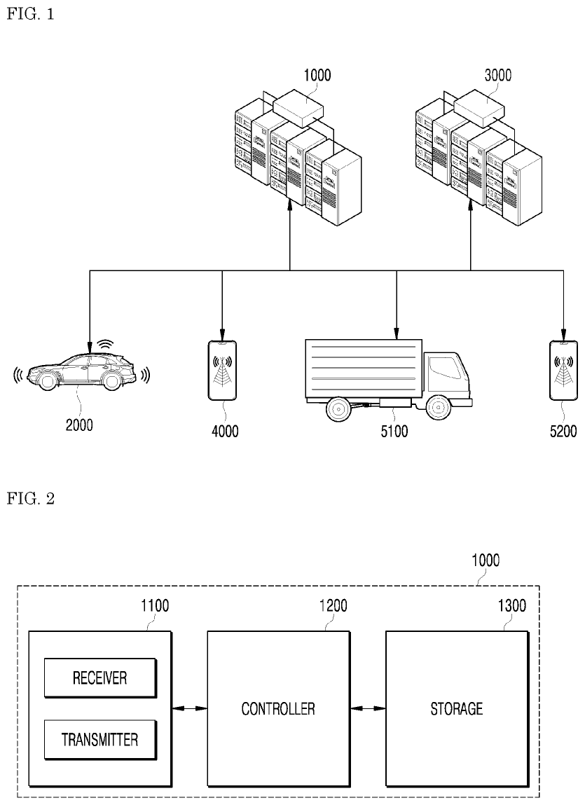

FIG. 1 is a diagram illustrating a system to which an apparatus for providing parcel delivery service by using an autonomous vehicle, according to an embodiment of the present disclosure, is applied.

A server 1000 may receive, from an orderer terminal 4000, order information indicating that a parcel receiving method is determined as being received by an autonomous vehicle 2000.

At this time, the server 1000 may determine a reception location to stop a parcel delivery vehicle 5100 at an apartment parking lot or an empty lot near a house, and may request an autonomous driving server 3000 to call the autonomous vehicle 2000 so that the autonomous vehicle 2000 reaches the determined reception location at a predetermined time.

The server 1000 may determine a call schedule of the autonomous vehicle 2000 that is near a movement route of the parcel delivery vehicle 5100, according to a delivery list and a real-time location of the parcel delivery vehicle 5100, provided via a courier terminal 5200, and may call the autonomous vehicle 2000 in an order that makes it easy to unload a delivery article according to a reception location and a weight or size of the delivery article.

The orderer terminal 4000 may request a security key to be included in the order information to the autonomous driving server 3000, before transmitting the order information to the server 1000. Here, the security key may be preferably a one-time security key for parcel delivery, and may be a one-time key that is deactivated as the server 1000 confirms that the delivery article has been received by means of a delivery image transmitted by the courier terminal 5200.

The courier terminal 5200 may have a dedicated parcel delivery management application for performing a service that provides parcel delivery service by using an autonomous vehicle.

FIG. 2 is a block diagram illustrating an apparatus for providing parcel delivery service by using an autonomous vehicle installed on a server side according to an embodiment of the present disclosure.

Referring to FIG. 2, the apparatus for providing parcel delivery service by using the autonomous vehicle may include a transceiver 1100, a controller 1200, and a storage 1300.

Depending on the embodiment, the server 1000 to which the apparatus for providing parcel delivery service by using an autonomous vehicle is applied may include components other than the components illustrated in FIG. 2 and described below, or may not include some of the components illustrated in FIG. 2 and described below.

The transceiver 1100 may include a receiver and a transmitter.

The transceiver 1100 may receive order information from the orderer terminal 4000, and may transmit the received order information to the controller 1200. At this time, the order information may include information about a delivery article, a delivery destination, a delivery method, and a security key. In this case, the information about the delivery article may include weight information of the delivery article. In addition, the delivery method may be any one delivery method that is selected and set by an orderer among a direct receiving method, a method using an unmanned parcel box, a method using a security office, and a method using an autonomous vehicle.

The transceiver 1100 may receive delivery schedule information from the controller 1200 and may transmit the delivery schedule information to the courier terminal 5200 or the orderer terminal 4000 under the control of the controller 1200. Here, the delivery schedule information may include a reception location and an estimated reception time for the delivery article.

The transceiver 1100 may transmit a security key provided from the orderer terminal 4000 to the autonomous driving server 3000 or the autonomous vehicle 2000 under the control of the controller 1200. Here, the security key may include information for unlocking a loadable space of the autonomous vehicle 2000.

The transceiver 1100 may receive traffic information from, for example, an intelligent transport system (ITS) server, and may transmit the received traffic information to the controller 1200.

The transceiver 1100 may receive an autonomous vehicle call signal generated based on the delivery schedule information from the controller 1200, and may transmit the autonomous vehicle call signal to the autonomous driving server 3000 or the autonomous vehicle 2000 under the control of the controller 1200.

The controller 1200 may generate delivery schedule information based on the order information provided by the orderer terminal 4000.

The controller 1200 may determine an estimated reception time for the delivery article by estimating, based on a delivery destination, a time required to move from a departure location of the parcel delivery vehicle 5100 to the delivery destination.

The controller 1200 may determine a reception location for the delivery article based on the delivery destination and a weight of the delivery article. Here, the reception location for the delivery article may include both a location where the parcel delivery vehicle 5100 that delivers the delivery article stops to unload the delivery article and a location where the autonomous vehicle 2000 stops to load the delivery article.

The controller 1200 may determine a place where it is possible to stop for a predetermined time or more so that the parcel delivery vehicle 5100 and the autonomous vehicle 2000 are adjacent to each other, and may determine stopping locations for the parcel delivery vehicle 5100 and the autonomous vehicle 2000 within the determined place.

The controller 1200 may determine a distance between the parcel delivery vehicle 5100 that delivers the delivery article and the autonomous vehicle 2000 that receives the delivery article to be inversely proportional to the weight of the delivery article. That is, when the delivery article which the autonomous vehicle 200 is to receive is heavy, the controller 1200 may determine a reception location so that the autonomous vehicle 200 is called to a stopping location close to the parcel delivery vehicle 5100, and when the delivery article which the autonomous vehicle 200 is to receive is light, the controller 1200 may determine the reception location so that the autonomous vehicle 200 is called to a stopping location slightly away from the parcel delivery vehicle 5100.

The controller 1200 may receive traffic information via the transceiver 1100, and in particular, the receiver, and may update the delivery schedule information based on the traffic information.

The controller 1200 may generate an autonomous vehicle call signal based on the delivery schedule information, and may transmit the generated autonomous vehicle call signal to the autonomous driving server 3000 or the autonomous vehicle 2000 via the transceiver 1100, and in particular, the transmitter.

The controller 1200 may determine the reception location for the delivery article based on a regional characteristic of the delivery destination. In addition, the controller 1200 may determine a call range to transmit the autonomous vehicle call signal according to the regional characteristic based on or focusing on the reception location for the delivery article. At this time, the regional characteristic may mean a characteristic relating to presence or absence of a parking lot and a characteristic relating to whether an external vehicle is accessible.

In order to receive the delivery article, it is required to secure not only stopping spaces of the parcel delivery vehicle 5100 and the autonomous vehicle 2000, but also a space for unloading the article. Therefore, when the delivery destination is an apartment or a large building, the controller 1200 may determine a parking lot within an apartment complex or within a building as the reception location for the delivery article. When the delivery destination is an ordinary housing complex, the controller 1200 may determine a space contracted and selected in advance, such as a public parking lot near the housing complex, a gas station, or a large parking lot of a mart, as the reception location for the delivery article.

When the reception location for the delivery article is a parking lot within an apartment complex or within a building, the controller 1200 may limit the call range of the autonomous vehicle call signal to the inside of the corresponding complex or building in consideration of an issue related to the location being inaccessible by an external vehicle. In addition, when the reception location for the delivery article is a space contracted and selected in advance, the controller 1200 may determine, in advance, the call range of the autonomous vehicle call signal in consideration of the reception location for previously delivered articles and future articles to be delivered. At this time, the controller 1200 may preferably determine the call range so that a distance required to move for each autonomous vehicle 2000 to receive the article is minimized.

The storage 1300 may store the order information received by, for example, the transceiver 1100, the delivery schedule information generated by the controller 1200, and the call range of the autonomous vehicle call signal.

The storage 1300 may be various storage devices such as a ROM, a RAM, an EPROM, a flash drive, and a hard drive, in terms of hardware. The storage 1300 may store various data for overall operation of the server 1000, such as a program for processing or controlling the controller 1200, in particular user propensity information. Here, the storage 1300 may be formed integrally with the controller 1200 or may be implemented as a sub-component of the controller 1200.

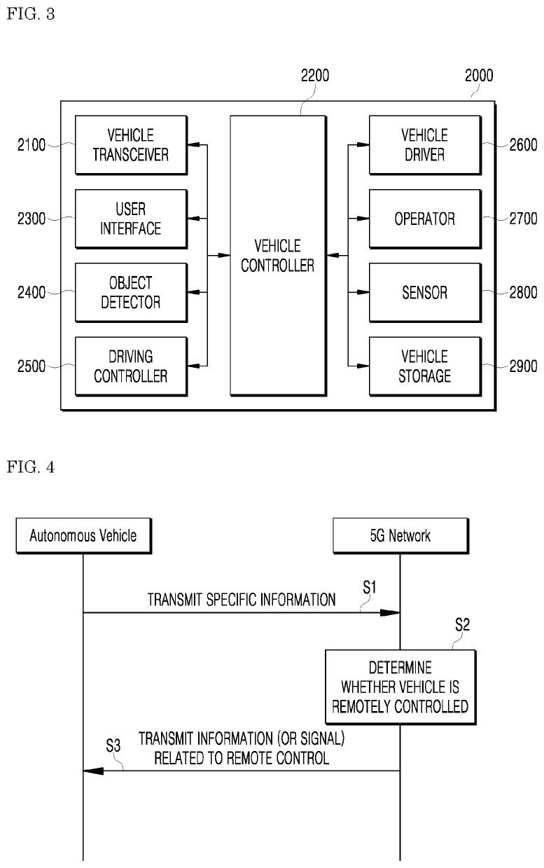

FIG. 3 is a block diagram illustrating an apparatus for providing parcel delivery service by using an autonomous vehicle installed on a vehicle side according to an embodiment of the present disclosure.

Referring to FIG. 3, the apparatus for providing parcel delivery service by using an autonomous vehicle may include a vehicle transceiver 2100, a vehicle controller 2200, a user interface 2300, an object detector 2400, a driving controller 2500, and a vehicle driver 2600, an operator 2700, a sensor 2800, and a vehicle storage 2900.

Depending on the embodiment, the vehicle 2000 to which the apparatus is applied may include components other than the components illustrated in FIG. 3 and described below, or may not include some of the components illustrated in FIG. 3 and described below.

The vehicle 2000 may be switched from an autonomous driving mode to a manual mode, or switched from the manual mode to the autonomous driving mode depending on the driving situation. Here, the driving situation may be judged by at least one of the information received by the vehicle transceiver 2100, the external object information detected by the object detector 2400, or the navigation information acquired by the navigation module.

The vehicle 2000 may be switched from the autonomous driving mode to the manual mode, or from the manual mode to the autonomous driving mode, according to a user input received through the user interface 2300.

When the vehicle 2000 is operated in the autonomous driving mode, the vehicle 2000 may be operated under the control of the operator 2700 that controls driving, parking, and unparking. When the vehicle 2000 is operated in the manual mode, the vehicle 2000 may be operated by an input of the driver's mechanical driving operation.

The vehicle transceiver 2100 may be a module for performing communication with an external device. Here, the external device may be the servers 1000 and 3000, the orderer terminal 4000, and the courier terminal 5200.

The vehicle transceiver 2100 may include a vehicle receiver and a vehicle transmitter.

The vehicle transceiver 2100 may receive the autonomous vehicle call signal from the server 1000 or the autonomous driving server 3000.

The vehicle transceiver 2100 may include at least one among a transmission antenna, a reception antenna, a radio frequency (RF) circuit capable of implementing various communication protocols, and an RF element in order to perform communication.

The vehicle transceiver 2100 may perform short range communication, GPS signal reception, V2X communication, optical communication, broadcast transmission/reception, and intelligent transport systems (ITS) communication functions.

The vehicle transceiver 2100 may further support other functions than the functions described, or may not support some of the functions described, depending on the embodiment.

The vehicle transceiver 2100 may support short-range communication by using at least one among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

The vehicle transceiver 2100 may form short-range wireless communication networks so as to perform short-range communication between the vehicle 2000 and at least one external device.

The vehicle transceiver 2100 may include a Global Positioning System (GPS) module or a Differential Global Positioning System (DGPS) module for obtaining location information of the vehicle 2000.

The vehicle transceiver 2100 may include a module for supporting wireless communication between the vehicle 2000 and a server (V2I: vehicle to infrastructure), communication with another vehicle (V2V: vehicle to vehicle) or communication with a pedestrian (V2P: vehicle to pedestrian). That is, the vehicle transceiver 2100 may include a V2X communication module. The V2X communication module may include an RF circuit capable of implementing V2I, V2V, and V2P communication protocols.

The vehicle transceiver 2100 may receive a danger information broadcast signal transmitted by another vehicle through the V2X communication module, and may transmit a danger information inquiry signal and receive a danger information response signal in response thereto.

The vehicle transceiver 2100 may include an optical communication module for performing communication with an external device via light. The optical communication module may include a light transmitting module for converting an electrical signal into an optical signal and transmitting the optical signal to the outside, and a light receiving module for converting the received optical signal into an electrical signal.

The light transmitting module may be formed to be integrated with the lamp included in the vehicle 2000.

The vehicle transceiver 2100 may include a broadcast communication module for receiving broadcast signals from an external broadcast management server, or transmitting broadcast signals to the broadcast management server through broadcast channels. The broadcast channel may include a satellite channel and a terrestrial channel. Examples of the broadcast signal may include a TV broadcast signal, a radio broadcast signal, and a data broadcast signal.

The vehicle transceiver 2100 may include an ITS communication module that exchanges information, data or signals with a traffic system. The ITS communication module may provide acquired information and data to the traffic system. The ITS communication module may receive information, data or signals from the traffic system. For example, the ITS communication module may receive road traffic information, that is, real-time traffic information, from the traffic system, and may provide the real-time traffic information to the vehicle controller 2200. For example, the ITS communication module may receive control signals from the traffic system and provide the control signals to the vehicle controller 2200 or a processor provided in the vehicle 2000.

Depending on the embodiment, the overall operation of each module of the vehicle transceiver 2100 may be controlled by a separate process provided in the vehicle transceiver 2100. The vehicle transceiver 2100 may include a plurality of processors, or may not include a processor. When a processor is not included in the vehicle transceiver 2100, the vehicle transceiver 2100 may be operated by either a processor of another apparatus in the vehicle 2000 or the vehicle controller 2200.

The vehicle transceiver 2100 may, together with the user interface 2300, implement a vehicle-use display device. In this case, the vehicle display device may be referred to as a telematics device or an audio video navigation (AVN) device.

The vehicle transceiver 2100 may receive the autonomous vehicle call signal based on a downlink (DL) grant of a 5G network connected to operate in the autonomous driving mode.

FIG. 4 is a diagram showing an example of a basic operation of an autonomous vehicle and a 5G network in a 5G communication system.

The vehicle transceiver 2100 may transmit specific information over a 5G network when the vehicle 2000 is operated in the autonomous driving mode (S1).

The specific information may include autonomous driving related information.

The autonomous driving related information may be information directly related to the driving control of the vehicle. For example, the autonomous driving related information may include at least one among object data indicating an object near the vehicle, map data, vehicle state data, vehicle location data, and driving plan data.

The autonomous driving related information may further include service information necessary for autonomous driving. For example, the specific information may include information about the destination and the safety level of the vehicle, which are inputted through the user interface 2300.

In addition, the 5G network may determine whether the vehicle is remotely controlled (S2).

The 5G network may include a server or a module for performing remote control related to autonomous driving.

The 5G network may transmit information (or a signal) related to the remote control to an autonomous vehicle (S3).

As described above, information related to the remote control may be a signal directly applied to the autonomous vehicle, and may further include service information necessary for autonomous driving. The autonomous vehicle according to this embodiment may receive service information such as insurance for each interval selected on a driving route and risk interval information, through a server connected to the 5G network to provide services related to the autonomous driving.

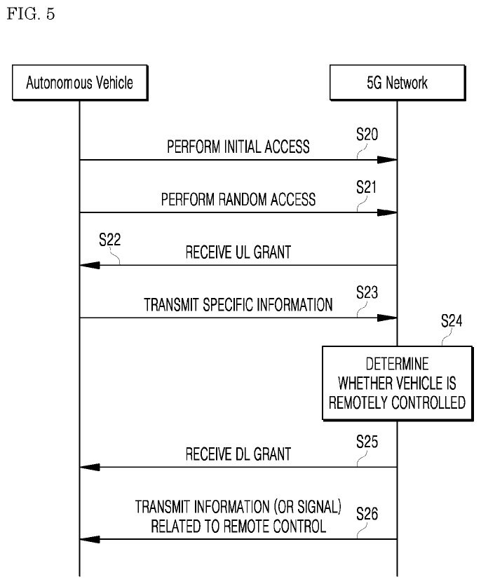

An essential process for performing 5G communication between the autonomous vehicle 2000 and the 5G network (for example, an initial access process between the vehicle 2000 and the 5G network) will be briefly described with reference to FIG. 5 to FIG. 9 below.

An example of application operations through the autonomous vehicle 2000 performed in the 5G communication system and the 5G network is as follows.

The vehicle 2000 may perform an initial access process with the 5G network (initial access step, S20). In this case, the initial access process includes a cell search process for acquiring DL synchronization and a process for acquiring system information.

The vehicle 2000 may perform a random access process with the 5G network (random access step, S21). At this time, the random access process may include an uplink (UL) synchronization acquisition process or a preamble transmission process for UL data transmission, a random access response reception process, and the like.

The 5G network may transmit an uplink (UL) grant for scheduling transmission of specific information to the autonomous vehicle 2000 (UL grant receiving step, S22).

The procedure by which the vehicle 2000 receives the UL grant includes a scheduling process in which a time/frequency resource is allocated for transmission of UL data to the 5G network.

The autonomous vehicle 2000 may transmit specific information over the 5G network based on the UL grant (specific information transmission step, S23).

The 5G network may determine whether the vehicle 2000 is to be remotely controlled based on the specific information transmitted from the vehicle 2000 (vehicle remote control determination step, S24).

The autonomous vehicle 2000 may receive the DL grant through a physical DL control channel for receiving a response on pre-transmitted specific information from the 5G network (DL grant receiving step, S25).

The 5G network may transmit information (or a signal) related to the remote control to the autonomous vehicle 2000 based on the DL grant (remote control related information transmission step, S26).

A process in which the initial access process and/or the random access process between the 5G network and the autonomous vehicle 2000 is combined with the DL grant receiving process has been exemplified. However, the present disclosure is not limited thereto.

For example, an initial access process and/or a random access process may be performed through an initial access step, an UL grant receiving step, a specific information transmission step, a remote control determination step of the vehicle, and an information transmission step associated with remote control. Further, an initial access process and/or a random access process may be performed through a random access step, an UL grant reception step, a specific information transmission step, a remote control decision step of the vehicle, and an information transmission step associated with remote control. The autonomous vehicle 2000 may be controlled by the combination of an artificial intelligence (AI) operation and the DL grant receiving process through the specific information transmission step, the vehicle remote control determination step, the DL grant receiving step, and the remote control related information transmission step.

The operation of the autonomous vehicle 2000 described above is merely exemplary, but the present disclosure is not limited thereto.

For example, the operation of the autonomous vehicle 2000 may be performed by selectively combining the initial access step, the random access step, the UL grant receiving step, or the DL grant receiving step with the specific information transmission step, or the remote control related information transmission step. The operation of the autonomous vehicle 2000 may include the random access step, the UL grant receiving step, the specific information transmission step, and the remote control related information transmission step. The operation of the autonomous vehicle 2000 may include the initial access step, the random access step, the specific information transmission step, and the remote control related information transmission step. The operation of the autonomous vehicle 2000 may include the UL grant receiving step, the specific information transmission step, the DL grant receiving step, and the remote control related information transmission step.

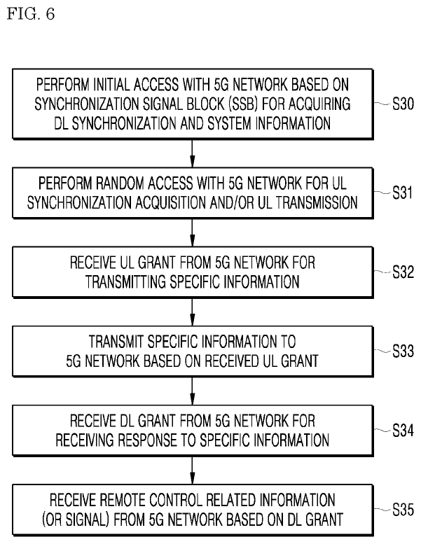

As illustrated in FIG. 6, the vehicle 2000 including an autonomous driving module may perform an initial access process with the 5G network based on Synchronization Signal Block (SSB) for acquiring DL synchronization and system information (initial access step, S30).

The autonomous vehicle 2000 may perform a random access process with the 5G network for UL synchronization acquisition and/or UL transmission (random access step, S31).

The autonomous vehicle 2000 may receive the UL grant from the 5G network for transmitting specific information (UL grant receiving step, S32).

The autonomous vehicle 2000 may transmit the specific information to the 5G network based on the UL grant (specific information transmission step, S33).

The autonomous vehicle 2000 may receive the DL grant from the 5G network for receiving a response to the specific information (DL grant receiving step, S34).

The autonomous vehicle 2000 may receive remote control related information (or a signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

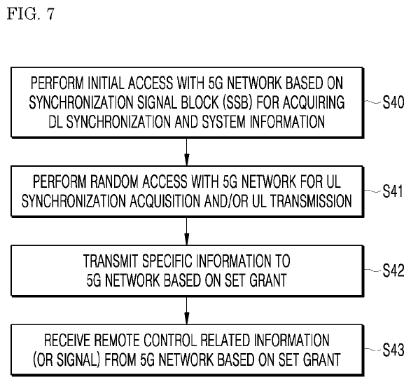

As illustrated in FIG. 7, the autonomous vehicle 2000 may perform an initial access process with the 5G network based on SSB for acquiring DL synchronization and system information (initial access step, S40).

The autonomous vehicle 2000 may perform a random access process with the 5G network for UL synchronization acquisition and/or UL transmission (random access step, S41).

The autonomous vehicle 2000 may transmit specific information based on a configured grant to the 5G network (UL grant receiving step, S42). In other words, instead of receiving the UL grant from the 5G network, the configured grant may be received.

The autonomous vehicle 2000 may receive remote control related information (or a signal) from the 5G network based on the setting grant (remote control related information receiving step, S43).

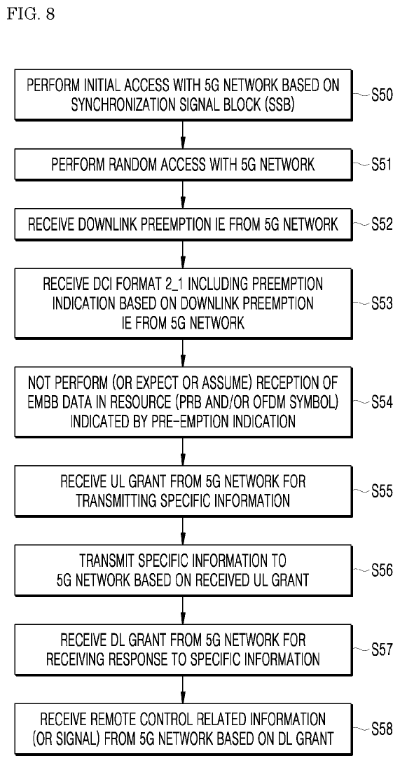

As illustrated in FIG. 8, the autonomous vehicle 2000 may perform an initial access process with the 5G network based on SSB for acquiring DL synchronization and system information (initial access step, S50).

The autonomous vehicle 2000 may perform a random access process with the 5G network for UL synchronization acquisition and/or UL transmission (random access step, S51).

In addition, the autonomous vehicle 2000 may receive DL Preemption and Information Element (IE) from the 5G network (DL Preemption IE reception step, S52).

The autonomous vehicle 2000 may receive Downlink Control Information (DCI) format 2_1 including preemption indication based on the DL preemption IE from the 5G network (DCI format 2_1 receiving step, S53).

The autonomous vehicle 2000 may not perform (or expect or assume) the reception of eMBB data in the resource (PRB and/or OFDM symbol) indicated by the pre-emption indication (step of not receiving eMBB data, S54).

The autonomous vehicle 2000 may receive the UL grant over the 5G network for transmitting specific information (UL grant receiving step, S55).

The autonomous vehicle 2000 may transmit the specific information to the 5G network based on the UL grant (specific information transmission step, S56).

The autonomous vehicle 2000 may receive the DL grant from the 5G network for receiving a response to the specific information (DL grant receiving step, S57).

The autonomous vehicle 2000 may receive the remote control related information (or signal) from the 5G network based on the DL grant (remote control related information receiving step, S58).

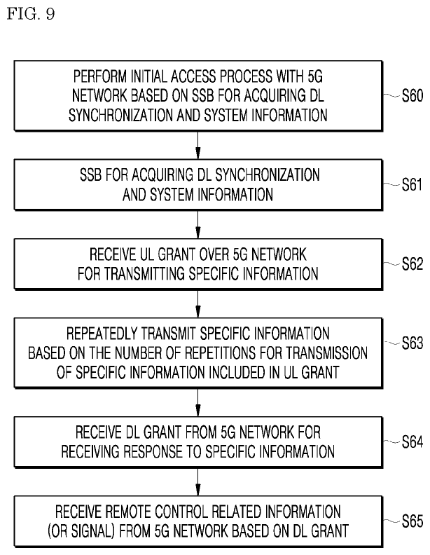

As illustrated in FIG. 9, the autonomous vehicle 2000 may perform an initial access process with the 5G network based on SSB for acquiring DL synchronization and system information (initial access step, S60).

The autonomous vehicle 2000 may perform a random access process with the 5G network for UL synchronization acquisition and/or UL transmission (random access step, S61).

The autonomous vehicle 2000 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous vehicle 2000 may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of 6 Resource Block (6RB) and 1 Resource Block (1RB).

The autonomous vehicle 2000 may receive the DL grant from the 5G network for receiving a response to the specific information (DL grant receiving step, S64).

The autonomous vehicle 2000 may receive the remote control related information (or signal) from the 5G network based on the DL grant (remote control related information receiving step, S65).

The above-described 5G communication technique may be applied in combination with the embodiment proposed in this specification, which will be described in FIG. 1 to FIG. 14B, or supplemented to specify or clarify the technical feature of the embodiment proposed in this specification.

The vehicle 2000 may be connected to an external server through a communication network, and may be capable of moving along a predetermined route without a driver's intervention by using an autonomous driving technique.

In the following embodiments, the user may be interpreted as a driver, a passenger, or the owner of a user terminal.

While the vehicle 2000 is driving in the autonomous driving mode, the type and frequency of accident occurrence may depend on the capability of the vehicle 1000 of sensing dangerous elements in the vicinity in real-time. The route to the destination may include sectors having different levels of risk due to various causes such as weather, terrain characteristics, traffic congestion, and the like.

At least one among an autonomous vehicle, a user terminal, and a server according to embodiments of the present disclosure may be associated or integrated with an AI module, a drone (unmanned aerial vehicle (UAV)), a robot, an augmented reality (AR) device, a virtual reality (VR) device, a 5G service related device, and the like.

For example, the vehicle 2000 may operate in association with at least one artificial intelligence module or robot included in the vehicle 2000 in the autonomous driving mode.

For example, the vehicle 2000 may interact with at least one robot. The robot may be an autonomous mobile robot (AMR). The mobile robot is capable of moving by itself, may freely move, and may be equipped with a plurality of sensors so as to be capable of avoiding obstacles during traveling. The mobile robot may be a flying robot (for example, a drone) having a flight device. The mobile robot may be a wheeled robot having at least one wheel and moving by means of the rotation of the wheel. The mobile robot may be a legged robot having at least one leg and being moved using the leg.

The robot may function as a device that complements the convenience of a vehicle user. For example, the robot may perform a function of moving a load placed on the vehicle 2000 to the final destination of the user. For example, the robot may perform a function of guiding the user, who has alighted from the vehicle 2000, to the final destination. For example, the robot may perform a function of transporting the user, who has alighted from the vehicle 2000, to the final destination.

At least one electronic device included in the vehicle 2000 may communicate with the robot through a communication device.

At least one electronic device included in the vehicle 2000 may provide the robot with data processed by at least one electronic device included in the vehicle. For example, at least one electronic device included in the vehicle 2000 may provide the robot with at least one of object data indicating an object around the vehicle, HD map data, vehicle state data, vehicle location data, or driving plan data.

At least one electronic device included in the vehicle 2000 may receive data processed by the robot from the robot. At least one electronic device included in the vehicle 2000 may receive at least one of sensing data, object data, robot state data, robot location data, and movement plan data of the robot, which are generated by the robot.

At least one electronic device included in the vehicle 2000 may generate a control signal based on data received from the robot. For example, at least one electronic device included in the vehicle may compare the information about the object generated by the object detection device with the information about the object generated by the robot, and generate a control signal based on the comparison result. At least one electronic device included in the vehicle 2000 may generate a control signal so as to prevent interference between the route of the vehicle and the route of the robot.

At least one electronic device included in the vehicle 2000 may include a software module or a hardware module for implementing an AI (hereinafter referred to as an AI module). At least one electronic device included in the vehicle may input the acquired data to the AI module, and use the data which is outputted from the AI module.

The AI module may perform machine learning on input data using at least one artificial neural network (ANN). The AI module may output driving plan data through machine learning on the input data.

At least one electronic device included in the vehicle 2000 may generate a control signal based on data which is outputted from the AI module.

At least one electronic device included in the vehicle 2000 may receive data processed by AI, from an external device, via a communication device, depending on the embodiment. At least one electronic device included in the vehicle 1000 may generate a control signal based on data processed by AI.

The vehicle controller 2200 may receive a control signal of the server 1000 via the vehicle transceiver 2100, and may control an autonomous driving mode operation according to the control signal.

The vehicle controller 2220 may control, in response to receiving the autonomous vehicle call signal from the server 1000 or the autonomous driving server 3000, an operation of the operator 2700 to reach a reception location at an estimated reception time designated by the autonomous vehicle call signal based on the real-time traffic information received from, for example, an ITS server.

The vehicle controller 2200 may unlock a door of a loadable space, such as a seat or a trunk, in response to reception of the security key via the vehicle transceiver 2100.

The vehicle controller 2200 may be implemented using at least one among application specific integrated circuits (ASICs), digital signal processors (DSPs), digital signal processing devices (DSPDs), programmable logic devices (PLDs), field [programmable gate arrays (FPGAs), processors, controllers, micro-controllers, microprocessors, and other electronic units for performing other functions.

The user interface 2300 may allow interaction between the vehicle 2000 and a vehicle user, receive an input signal of the user, transmit the received input signal to the vehicle controller 2200, and provide information included in the vehicle 2000 to the user under the control of the vehicle controller 2200. The user interface 2300 may include, but is not limited to, an input module, an internal camera, a bio-sensing module, and an output module.

The input module is for receiving information from a user. The data collected by the input module may be analyzed by the vehicle controller 2200 and processed by the user's control command.

The input module may receive the destination of the vehicle 2000 from the user and provide the destination to the controller 2200.

The input module may be disposed inside the vehicle. For example, the input module may be disposed on one area of a steering wheel, one area of an instrument panel, one area of a seat, one area of each pillar, one area of a door, one area of a center console, one area of a head lining, one area of a sun visor, one area of a windshield, or one area of a window.

The output module is for generating an output related to visual, auditory, or tactile information. The output module may output a sound or an image.

The output module may include at least one of a display module, an acoustic output module, and a haptic output module.

The display module may display graphic objects corresponding to various information.

The display module may include at least one of a liquid crystal display (LCD), a thin film transistor liquid crystal display (TFT LCD), an organic light emitting diode (OLED), a flexible display, a 3D display, or an e-ink display.

The display module may have a mutual layer structure with a touch input module, or may be integrally formed to implement a touch screen.

The display module may be implemented as a Head Up Display (HUD). When the display module is implemented as an HUD, the display module may include a projection module to output information through an image projected onto a windshield or a window.

The display module may include a transparent display. The transparent display may be attached to the windshield or the window.

The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted.

The user interface 2300 may include a plurality of display modules.

The display module may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The sound output module may convert an electrical signal provided from the vehicle controller 2200 into an audio signal. To this end, the sound output module may include one or more speakers.

The haptic output module may generate a tactile output. For example, the haptic output module may operate to allow the user to perceive the output by vibrating a steering wheel, a seat belt, and a seat.

The object detector 2400 is for detecting an object located outside the vehicle 2000. The object detector 2400 may generate object information based on the sensing data, and transmit the generated object information to the vehicle controller 2200. At this time, the object may include various objects related to the driving of the vehicle 2000, such as a lane, another vehicle, a pedestrian, a motorcycle, a traffic signal, a light, a road, a structure, a speed bump, a landmark, and an animal.

The object detector 2400, which is a plurality of sensor modules, may include a camera module, a light imaging detection and ranging (LIDAR), an ultrasonic sensor, a radio detection and ranging (RADAR), and an infrared sensor.

The object detector 2400 may sense environmental information around the vehicle 2000 through the plurality of sensor modules.

Depending on the embodiment, the object detector 2400 may further include components other than the components described, or may not include some of the components described.

The RADAR may include an electromagnetic wave transmitting module and an electromagnetic wave receiving module. The RADAR may be implemented by a pulse RADAR system or a continuous wave RADAR system in terms of the radio wave emission principle. The RADAR may be implemented using a frequency modulated continuous wave (FMCW) method or a frequency shift keying (FSK) method according to a signal waveform in a continuous wave RADAR method.

The RADAR may detect an object based on a time-of-flight (TOF) scheme or a phase-shift scheme by using an electromagnetic wave as a medium, and may detect the position of the detected object, the distance to the detected object, and a relative speed of the detected object.

The RADAR may be disposed at an appropriate location outside the vehicle for sensing an object disposed at the front, back, or side of the vehicle.

The LIDAR may include a laser transmitting module and a laser receiving module. The LIDAR may be implemented in a TOF scheme or a phase-shift scheme.

The LIDAR may be implemented as a driven type or a non-driven type.

When the LIDAR is embodied in the driving method, the LIDAR may rotate by means of a motor, and detect an object near the vehicle 2000. When the LIDAR is implemented in the non-driving method, the LIDAR may detect an object within a predetermined range with respect to the vehicle 2000 by means of light steering. The vehicle 2000 may include a plurality of non-driven type LIDARs.

The LIDAR may detect an object based on a TOF scheme or a phase-shift scheme by using a laser beam as a medium, and may detect the location of the detected object, the distance to the detected object, and the relative speed of the detected object.

The LIDAR may be disposed at an appropriate location outside the vehicle for sensing an object disposed at the front, back, or side of the vehicle.

The image capturer may be disposed at a suitable place outside the vehicle, for example, the front, back, right side mirrors and the left side mirror of the vehicle, in order to acquire a vehicle exterior image. The image capturer may be a mono camera, but is not limited thereto, and may be a stereo camera, an around view monitoring (AVM) camera, or a 360 degree camera.

The image capturer may be disposed close to the front windshield in the interior of the vehicle in order to acquire an image of the front of the vehicle. The image capturer may be disposed around the front bumper or the radiator grill.

The image capturer may be disposed close to the rear glass in the interior of the vehicle in order to acquire an image of the back of the vehicle. The image capturer may be disposed around the rear bumper, the trunk, or the tail gate.

The image capturer may be disposed close to at least one of the side windows in the interior of the vehicle in order to acquire an image of the side of the vehicle. In addition, the image capturer may be disposed around the fender or the door.

The ultrasonic sensor may include an ultrasonic transmission module and an ultrasonic reception module. The ultrasonic sensor may detect an object based on ultrasonic waves, and may detect the location of the detected object, the distance to the detected object, and the relative speed of the detected object.

The ultrasonic sensor may be disposed at an appropriate location outside the vehicle for sensing an object at the front, back, or side of the vehicle.

The infrared sensor may include an infrared transmission module and an infrared reception module. The infrared sensor may detect an object based on the infrared light, and may detect the location of the detected object, the distance to the detected object, and the relative speed of the detected object.

The infrared sensor may be disposed at an appropriate location outside the vehicle in order to sense objects located at the front, rear, or side portions of the vehicle.

The vehicle controller 2200 may control the overall operation of the object detector 2400.

The vehicle controller 2200 may compare data sensed by the RADAR, the LIDAR, the ultrasonic sensor, and the infrared sensor with pre-stored data so as to detect or classify an object.

The vehicle controller 2200 may detect an object and perform tracking of the object based on the obtained image. The vehicle controller 2200 may perform operations such as calculation of the distance from an object and calculation of the relative speed of the object through image processing algorithms.

For example, the vehicle controller 2200 may obtain the distance information from the object and the relative speed information of the object from the obtained image based on the change of size of the object over time.

For example, the vehicle controller 2200 may obtain the distance information from the object and the relative speed information of the object through, for example, a pin hole model and road surface profiling.

The vehicle controller 2200 may detect an object and perform tracking of the object based on the reflected electromagnetic wave reflected back from the object. The vehicle controller 2200 may perform operations such as calculation of the distance to the object and calculation of the relative speed of the object based on the electromagnetic waves.

The vehicle controller 2200 may detect an object, and perform tracking of the object based on the reflected laser light reflected back from the object. Based on the laser light, the vehicle controller 2200 may perform operations such as calculation of the distance to the object and calculation of the relative speed of the object based on the laser light.

The vehicle controller 2200 may detect an object and perform tracking of the object based on the reflected ultrasonic wave reflected back from the object. The vehicle controller 2200 may perform operations such as calculation of the distance to the object and calculation of the relative speed of the object based on the reflected ultrasonic wave.

The vehicle controller 2200 may detect an object and perform tracking of the object based on the reflected infrared light reflected back from the object. The vehicle controller 2200 may perform operations such as calculation of the distance to the object and calculation of the relative speed of the object based on the infrared light.

Depending on the embodiment, the object detector 2400 may include a separate processor from the vehicle controller 2200. In addition, each of the RADAR, the LIDAR, the ultrasonic sensor and the infrared sensor may include a processor.

When a processor is included in the object detector 2400, the object detector 2400 may be operated under the control of the processor controlled by the vehicle controller 2200.

The driving controller 2500 may receive a user input for driving. In the case of the manual mode, the vehicle 2000 may operate based on the signal provided by the driving controller 2500.

The vehicle driver 2600 may electrically control the driving of various apparatuses in the vehicle 2000. The vehicle driver 2600 may electrically control the driving of a power train, a chassis, a door/window, a safety device, a lamp, and an air conditioner in the vehicle 2000.

The operator 2700 may control various operations of the vehicle 2000. The operator 2700 may operate in the autonomous driving mode.

The operator 2700 may include a driving module, an unparking module, and a parking module.

Depending on the embodiment, the operator 2700 may further include constituent elements other than the components to be described, or may not include some of the components.

The operator 2700 may include a processor under the control of the vehicle controller 2200. Each module of the operator 2700 may include a processor individually.

Depending on the embodiment, when the operator 2700 is implemented as software, it may be a sub-concept of the vehicle controller 2200.

The driving module may perform driving of the vehicle 2000.

The driving module may receive object information from the object detector 2400, and provide a control signal to a vehicle driving module to perform the driving of the vehicle 2000.

The driving module may receive a signal from an external device through the vehicle transceiver 2100, and provide a control signal to the vehicle driving module, so that the driving of the vehicle 2000 may be performed.

The unparking module may perform unparking of the vehicle 2000.

The unparking module may receive navigation information from the navigation module, and provide a control signal to the vehicle driving module to perform the departure of the vehicle 2000.

In the unparking module, object information may be received from the object detector 2400, and a control signal may be provided to the vehicle driving module, so that the unparking of the vehicle 2000 may be performed.

In the unparking module, a signal may be provided from an external device through the vehicle transceiver 2100, and a control signal may be provided to the vehicle driving module, so that the unparking of the vehicle 2000 may be performed.

The parking module may perform parking of the vehicle 2000.

The parking module may receive navigation information from the navigation module, and provide a control signal to the vehicle driving module to perform the parking of the vehicle 2000.

In the parking module, object information may be provided from the object detector 2400, and a control signal may be provided to the vehicle driving module, so that the parking of the vehicle 2000 may be performed.

In the parking module, a signal may be provided from the external device through the vehicle transceiver 2100, and a control signal may be provided to the vehicle driving module so that the parking of the vehicle 2000 may be performed.

The navigation module may provide the navigation information to the vehicle controller 2200. The navigation information may include at least one of map information, set destination information, route information according to destination setting, information about various objects on the route, lane information, or current location information of the vehicle.

The navigation module may include a memory. The memory may store navigation information. The navigation information may be updated by information received through the vehicle transceiver 2100. The navigation module may be controlled by an internal processor, or may operate by receiving an external signal, for example, a control signal from the vehicle controller 2200, but the present disclosure is not limited thereto.

The driving module of the operator 2700 may be provided with the navigation information from the navigation module, and may provide a control signal to the vehicle driving module so that driving of the vehicle 2000 may be performed.

The sensor 2800 may sense the state of the vehicle 2000 using a sensor mounted on the vehicle 2000, that is, a signal related to the state of the vehicle 2000, and obtain movement route information of the vehicle 2000 according to the sensed signal. The sensor 2800 may provide the obtained movement route information to the vehicle controller 2200.

The sensor 2800 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 2800 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 2800 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS).

The sensor 2800 may generate vehicle state information based on sensing data. The vehicle state information may be information generated based on data sensed by various sensors provided in the vehicle.

The vehicle state information may include information such as attitude information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, interior temperature information of the vehicle, interior humidity information of the vehicle, pedal position information, and vehicle engine temperature information.

The vehicle storage 2900 may be electrically connected to the vehicle controller 2200. The vehicle storage 2900 may store basic data for each unit of the apparatus, control data for operation control of each unit of the apparatus, and input/output data. The vehicle storage 2900 may be various storage devices such as a ROM, a RAM, an EPROM, a flash drive, and a hard drive, in terms of hardware. The vehicle storage 2900 may store various data for overall operation of the vehicle 2000, such as a program for processing or controlling the vehicle controller 2200, in particular driver propensity information. The vehicle storage 2900 may be integrally formed with the vehicle controller 2200, or implemented as a sub-component of the vehicle controller 2200.

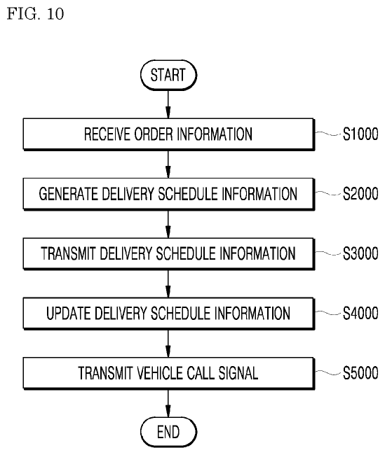

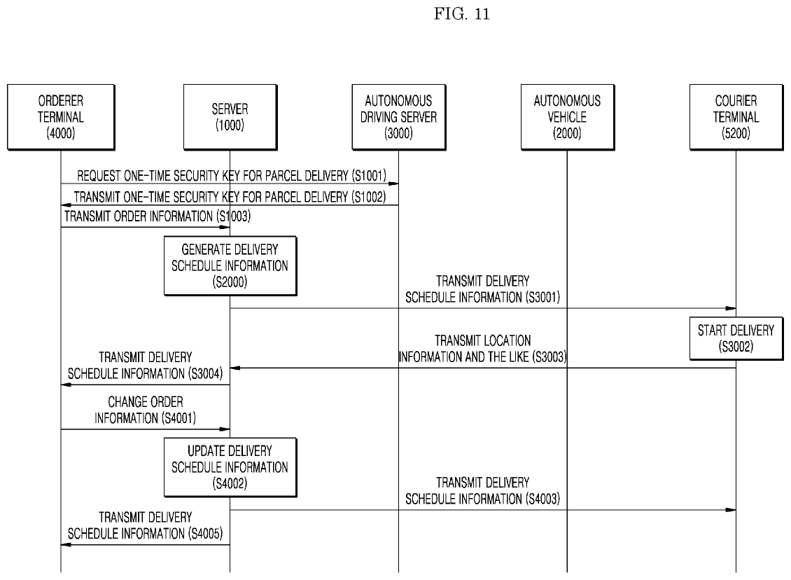

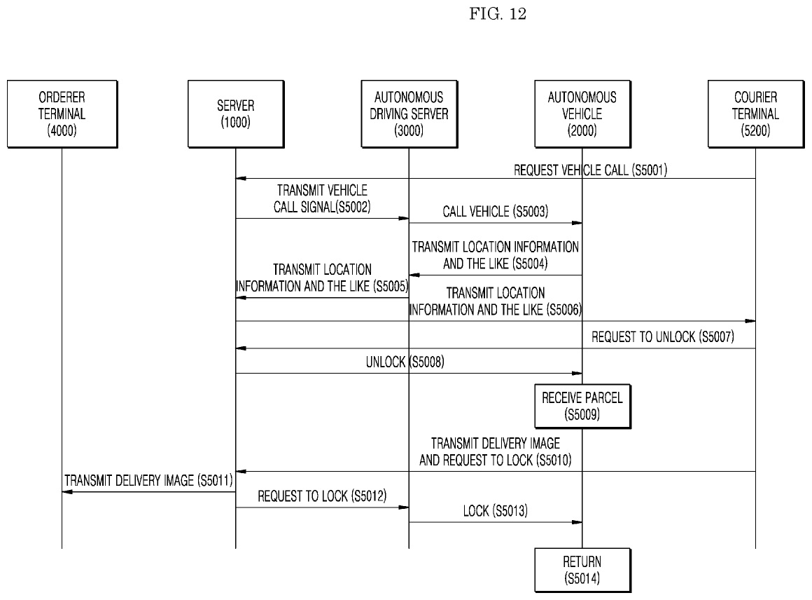

FIGS. 10 to 12 are operational flow diagrams illustrating a method for providing parcel delivery service by using an autonomous vehicle according to an embodiment of the present disclosure.

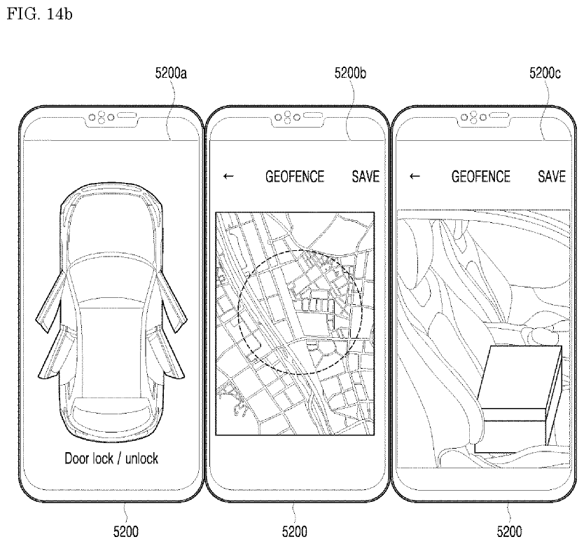

FIGS. 13 to 14B are diagrams illustrating an operation of an apparatus for providing parcel delivery service by using an autonomous vehicle according to an embodiment of the present disclosure.

The apparatus for providing parcel delivery service by using an autonomous vehicle may include steps other than the steps illustrated in FIGS. 10 to 12 and described below, or may not include some of the steps illustrated in FIGS. 10 to 12 and described below.

As illustrated in FIG. 10, the server 1000 may receive order information from the orderer terminal 4000 (S1000).

The server 1000 may generate delivery schedule information based on the order information provided by the orderer terminal 4000 (S2000).

The server 1000 may transmit the generated delivery schedule information to the courier terminal 5200 or the orderer terminal 4000 (S3000).

The server 1000 may update the delivery schedule information based on the changed order information received from the orderer terminal 4000 or real-time traffic information received from the ITS server (S4000).

The server 1000 may generate an autonomous vehicle call signal based on the delivery schedule information, and may transmit the generated autonomous vehicle call signal to the autonomous driving server 3000 or the autonomous vehicle 2000 (S5000).

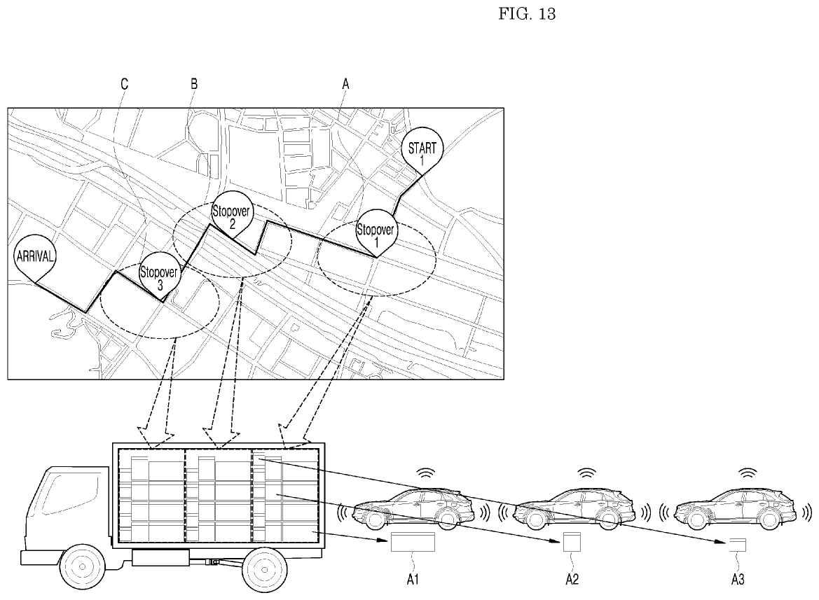

As illustrated in FIG. 11, an orderer who orders a delivery article may transmit order information to the server 1000 via the orderer terminal 4000 (S1003), and may request a one-time security key for parcel delivery to the autonomous driving server 3000 via the orderer terminal 4000 before transmitting the order information, so as to include the security key in the order information (S1001).

When the autonomous driving server 3000 receives a request for the security key from the orderer terminal 4000, the autonomous driving server 3000 may identify whether the request of the orderer terminal 4000 is a request to which authorization is granted. When the request is a request to which authorization is granted, the autonomous driving server 3000 may transmit the one-time security key for parcel delivery to the orderer terminal 4000 (S1002).

The server 1000 may generate delivery schedule information based on the order information provided by the orderer terminal 4000 (S2000), and may transmit the generated delivery schedule information to the courier terminal 5200 or the parcel delivery vehicle 5100 (S3001).

The server 1000 may designate a method for loading the delivery article to the parcel delivery vehicle 5100 according to the order information, and may transmit loading information including the designated loading method to the courier terminal 5200.

For example, as illustrated in FIG. 13, the server 1000 may determine areas A, B, and C to call the autonomous vehicle 2000 based on a stopping location for the parcel delivery vehicle 5100, and may generate loading information for classifying and loading delivery articles into the parcel delivery vehicle 5100 according to the determined area. In addition, the server 1000 may generate loading information for determining a loading location in the parcel delivery vehicle 5100 according to a weight of the delivery article. That is, as illustrated in FIG. 13, the server 1000 may generate, with respect to articles to be delivered to the area A, loading information for loading a heavy article close to a vehicle door and for loading a light article far from the vehicle door in an interior space of the parcel delivery vehicle 5100 allocated to the area A.

When delivery is started (S3002), location information, traffic conditions, and the like may be transmitted from the parcel delivery vehicle 5100 or the courier terminal 5200 to the server 1000 (S3003).

The server 1000 may update the delivery schedule information by reflecting, for example, the location information and traffic conditions received from the parcel delivery vehicle 5100 or the courier terminal 5200, and may transmit the updated delivery schedule information to the orderer terminal 4000 (S3004).

When the server 1000 receives the changed order information from the orderer terminal 4000 (S4001), the server 1000 may update the delivery schedule information based on the changed order information (S4002).

The server 1000 may transmit the updated delivery schedule information to the courier terminal 5200 or the orderer terminal 4000 (S4003 and S4005).

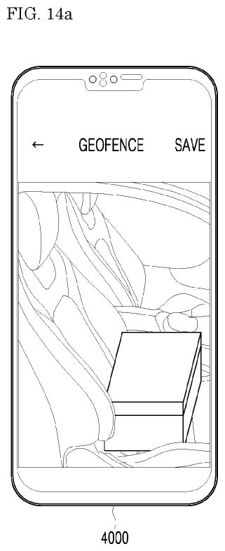

Referring to FIG. 12, the courier terminal 5200 may make a request, to the server 1000, to call the autonomous vehicle 2000 at a time determined in consideration of a reception location for the delivery article at which the parcel delivery vehicle 5100 is to stop and location information of the autonomous vehicle 2000 provided in advance (S5001). At this time, the courier terminal 5200 may transmit, to the server 1000, information about a current location of the parcel delivery vehicle 5100 or a location at which the parcel delivery vehicle 5100 is to stop, together with the call request.

The server 1000 may generate an autonomous vehicle call signal based on the delivery schedule information or the information provided by the courier terminal 5200, and may transmit the generated autonomous vehicle call signal to the autonomous driving server 3000 (S5002).

At this time, as the weight of the delivery article becomes heavier, the server 1000 may adjust a call time so that the autonomous vehicle receiving the article arrives earlier. That is, as illustrated in FIG. 13, a first vehicle that receives a heavy article A1 may preferably arrive first and stop the closest to the parcel delivery vehicle 5100. A second vehicle that receives an article A2 that is lighter than the article A1 may preferably arrive later than the first vehicle and stop next to the first vehicle. A third vehicle that receives an article A3 light than the article A2 may preferably arrive later than the second vehicle and stop next to the second vehicle. By adjusting the call time in this manner, a distance that a courier moves an article may be shortened as the article becomes heavier.

The autonomous driving server 3000 may call the autonomous vehicle 2000 determined based on the received autonomous vehicle call signal (S5003).

Here, the server 1000 may directly transmit the autonomous vehicle call signal to the autonomous vehicle 2000.

The called autonomous vehicle 2000 may transmit vehicle information such as location information corresponding to the autonomous vehicle 2000 to the autonomous driving server 3000 (S5004). At this time, the location information corresponding to the autonomous vehicle 2000 may be shared with the server 1000 and the courier terminal 5200 through transmission of information (S5005 and S5006). As illustrated in FIG. 14B, the courier terminal 5200 may display location information 5200b corresponding to the autonomous vehicle 2000 in the form of an image.

When the autonomous vehicle 2000 arrives at the reception location, the courier terminal 5200 may request the server 1000 to unlock a door of a loadable space such as a trunk of the autonomous vehicle 2000 (S5007). As illustrated in FIG. 14B, the courier terminal 5200 may provide an interface screen 5200a to display a request to lock and unlock the door of the autonomous vehicle 2000.

When the server 1000 receives a request to unlock the door from the courier terminal 5200, the server 1000 may unlock the door of the loadable space such as the trunk of the autonomous vehicle 2000 by using a security key included in the received order information. (S5008).

When the door of the loadable space of the autonomous vehicle 2000 is opened, a courier may put the delivery article into the loadable space (S5009). That is, the delivery article may be received by the autonomous vehicle 2000.

As illustrated in FIG. 14B, the courier terminal 5200 may acquire a delivery image 5200c, and may transmit the acquired delivery image to the server 1000 together with a request to lock the door of the autonomous vehicle 2000. (S5010).

The server 1000 may transmit the received delivery image to the orderer terminal 4000 (S5011), together with a request for the autonomous driving server 3000 to lock the door of the autonomous vehicle 2000 (S5012).

The orderer terminal 4000 may display the delivery image, as illustrated in FIG. 14A.

When the autonomous driving server 3000 receives a request to lock the door, from the server 1000, the autonomous driving server 3000 may lock the door of the autonomous vehicle 2000 (S5013).

After receiving a parcel and the door has been locked, the autonomous vehicle 2000 may return to the designated location (S5014). At this time, the courier terminal 5200 may be granted a one-time authorization for a return command, from the server 1000 or the autonomous driving server 3000, and may control the autonomous vehicle 2000 to return to the designated location, after the autonomous vehicle 2000 receives the article, according to the granted authorization.

The present disclosure described above may be implemented as a computer-readable code in a medium on which a program is recorded. The computer-readable medium includes all types of recording devices in which data readable by a computer system may be stored. Examples of computer readable media may include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and the computer readable medium may also be implemented in the form of a carrier wave (for example, transmission over the Internet). Moreover, the computer may include a processor or a controller. Accordingly, the above detailed description should not be construed as limiting in all aspects and should be considered as illustrative. The scope of the present disclosure should be determined by reasonable interpretation of the appended claims, and all changes within the equivalent scope of the present disclosure are included in the scope of the present disclosure.

### DESCRIPTION OF SYMBOLS

1000: Server
1100: Transceiver
1200: Controller
1300: Storage
2000: Autonomous vehicle
2100: Vehicle transceiver
2200: Vehicle controller
2300: User interface
2400: Object detector
2500: Driving controller
2600: Vehicle driver
2700: Operator
2800: Sensor
2900: Vehicle storage
3000: Autonomous driving server
4000: Orderer terminal
5100: Parcel delivery vehicle
5200: Courier terminal

What is claimed is:

1. An apparatus for providing delivery service by using an autonomous vehicle, the apparatus for providing delivery service comprising:
a receiver configured to receive order information;
a controller configured to generate delivery schedule information based on the order information; and
a transmitter configured to transmit the delivery schedule information under control of the controller, wherein
the order information includes a weight of a delivery article, a delivery destination, and a security key;
the delivery schedule information includes a reception location and an estimated reception time for the delivery article;
the transmitter transmits the security key under the control of the controller; and
the security key includes information for unlocking a loadable space of the autonomous vehicle that receives the delivery article.

2. The apparatus for providing delivery service according to claim 1, wherein
the controller determines the estimated reception time based on the delivery destination, and determines the reception location for the delivery article based on the delivery destination and the weight of the delivery article.

3. The apparatus for providing delivery service according to claim 2, wherein
in determining the reception location for the delivery article, the controller determines a distance between a parcel delivery vehicle that delivers the delivery article and the autonomous vehicle that receives the delivery article to be inversely proportional to the weight of the delivery article.

4. The apparatus for providing delivery service according to claim 1, wherein
the controller receives traffic information via the receiver, and updates the delivery schedule information based on the traffic information.

5. The apparatus for providing delivery service according to claim 2, wherein
the controller generates an autonomous vehicle call signal based on the delivery schedule information, and transmits the generated autonomous vehicle call signal via the transmitter.

6. The apparatus for providing delivery service according to claim 1, wherein
the security key is a one-time key that is deactivated in response to the reception of the delivery article being confirmed.

7. The apparatus for providing delivery service according to claim 5, wherein
the controller determines the reception location for the delivery article based on a regional characteristic of the delivery destination, and determines a call range to transmit the autonomous vehicle call signal according to the regional characteristic focusing on the reception location for the delivery article, and
the regional characteristic includes a characteristic relating to presence or absence of a parking lot and a characteristic relating to whether an external vehicle is accessible.

8. An apparatus for providing delivery service by using an autonomous vehicle, the apparatus for providing delivery service installed in the autonomous vehicle that communicates with a parcel delivery server that generates delivery schedule information based on order information including a security key and generates an autonomous vehicle call signal based on the generated delivery schedule information, comprising:
a vehicle receiver configured to receive the autonomous vehicle call signal and real-time traffic information; and
a vehicle controller configured to control an operation to reach a reception location at an estimated reception time designated by the autonomous vehicle call signal based on the real-time traffic information in response to reception of the autonomous vehicle call signal, wherein
the vehicle controller unlocks a door of a loadable space of the vehicle in response to reception of the security key via the vehicle receiver.

9. The apparatus for providing delivery service according to claim 8, wherein
the vehicle receiver receives the autonomous vehicle call signal based on a downlink (DL) grant of a 5G network connected to operate in an autonomous driving mode.

10. A method for providing delivery service by using an autonomous vehicle, the method for providing delivery service comprising:
receiving order information;
generating delivery schedule information based on the order information;
transmitting the delivery schedule information; and
transmitting a security key, wherein
the order information includes a weight of a delivery article, a delivery destination, and the security key,
the delivery schedule information includes a reception location and an estimated reception time for the delivery article,
the security key includes information for unlocking a loadable space of the autonomous vehicle that receives the delivery article.

11. The method for providing delivery service according to claim 10, wherein
the generating the delivery schedule information comprises:
determining the estimated reception time based on the delivery destination; and
determining the reception location for the delivery article based on the delivery destination and the weight of the delivery article.

12. The method for providing delivery service according to claim 11, wherein
the determining the reception location for the delivery article comprises determining a distance between a parcel delivery vehicle that delivers the delivery article and the autonomous vehicle that receives the delivery article to be inversely proportional to the weight of the delivery article.

13. The method for providing delivery service according to claim 10, further comprising:
receiving traffic information; and
updating the delivery schedule information based on the traffic information.

14. The method for providing delivery service according to claim 11, further comprising:
generating an autonomous vehicle call signal based on the delivery schedule information; and
transmitting the autonomous vehicle call signal.

15. The method for providing delivery service according to claim 10, wherein
the security key is a one-time key that is deactivated in response to the reception of the delivery article being confirmed.

16. The method for providing delivery service according to claim 14, wherein
the determining the reception location for the delivery article comprises:
determining the reception location for the delivery article based on a regional characteristic of the delivery destination; and
determining a call range to transmit the autonomous vehicle call signal according to the regional characteristic focusing on the reception location for the delivery article, and
the regional characteristic includes a characteristic relating to presence or absence of a parking lot and a characteristic relating to whether an external vehicle is accessible.

17. A method for providing delivery service by using an autonomous vehicle, the method for providing delivery service by using the autonomous vehicle that communicates with a parcel delivery server that generates delivery schedule information based on order information including a security key and generates an autonomous vehicle call signal based on the generated delivery schedule information, comprising:
receiving the autonomous vehicle call signal;
receiving real-time traffic information;
controlling an operation to reach a reception location at an estimated reception time based on the real-time traffic information in response to reception of the autonomous vehicle call signal; and
unlocking a loadable space of the vehicle in response to reception of the security key.

18. The method for providing delivery service according to claim 17, wherein
the receiving the autonomous vehicle call signal is receiving the autonomous vehicle call signal based on a DL grant of a 5G network connected to operate in an autonomous driving mode.

19. A computer-readable recording medium recording a program for providing delivery service by using an autonomous vehicle, the program for providing delivery service by using an autonomous vehicle causing a computer to perform:
receiving of order information;
generating of delivery schedule information based on the order information;
transmitting of the delivery schedule information; and
transmitting of a security key, wherein
the order information includes a weight of a delivery article, a delivery destination, and the security key,
the delivery schedule information includes a reception location and an estimated reception time for the delivery article, and
the security key includes information for unlocking a door of a loadable space of the autonomous vehicle.
